(19) United States
(12) Patent Application Publication
(10) Pub. No.: US 2009/0022627 A1
(43) Pub. Date: Jan. 22, 2009

(54) Adsorption fabric and method of fabricating the same

(75) Inventors: Sang Il Na, Osan-si (KR); Young-Kil Kim, Suwon-si (KR); Chang-Soo Kim, Yongin-si (KR); Hong-Jin Park, Yongin-si (KR); Jae-Woo Ryu, Osan-si (KR); Hyung-Kyu Han, Seoul (KR)

Correspondence Address: HARNESS, DICKEY & PIERCE, P.L.C., P.O. BOX 8910, RESTON, VA, 20195, US

(73) Assignee: Samsung Electronics Co., Ltd.

(21) Appl. No.: 12/216,532

(22) Filed: Jul. 7, 2008

(30) Foreign Application Priority Data
Jul. 18, 2007 (KR) 10-2007-0071510

(51) Int. Cl. G01N 30/00; B31B 1/60

(52) U.S. Cl. 422/69; 156/60

(57) ABSTRACT

A color-changing adsorption fabric is provided to identify an adsorption state of a type of chemical, e.g., acid, alkali or organic matter, the color change being generated through a chemical reaction between chemical solution and pH-indicator material after wiping the chemical solution with the fabric. An adsorption fabric used in wiping the chemical solution may include a material, whose color changes when contacting an acid, alkali or organic matter, thereby identifying a type of chemical solution and thus preventing or reducing a fire occurrence. The color change of the adsorption fabric used in wiping a chemical solution may be identified with the naked eye so that separating and disposing the used-adsorption fabric corresponding to a type of chemical may be easier.

### PRIORITY STATEMENT

This application claims priority under 35 U.S.C. § 119 to Korean Patent Application 10-2007-0071510, filed on Jul. 18, 2007, in the Korean Intellectual Property Office (KIPO), the entire contents of which are herein incorporated by reference for all purposes as if fully set forth herein.

### BACKGROUND

1. Field

Example embodiments relate to a color-changing adsorption fabric which identifies an adsorption state of a type of chemical, e.g., acid, alkali or organic matter, the color change being generated through a chemical reaction between chemical solution and pH-indicator material after wiping the chemical solution with the fabric.

2. Description of the Related Art

For an aldehyde group, there is not as much appropriate adsorption matter as compared with a smell component of alkalinity, e.g., ammonia and/or trimethylamine, or a smell component of acidity, e.g., hydrogen sulfide, methyl mercaptan and/or acetic acid. Many adsorption members having an aldehyde group as a main target, or many detection units to identify an adsorption state of an aldehyde group, have been proposed.

According to the conventional art, a formaldehyde adsorbent may be produced by adding pH indicator to inorganic ammonium salt. For example, when the inorganic ammonium salt adsorbs formaldehyde, acid may be dissociated from ammonium salt and the inorganic ammonium salt may have a color reaction to the pH indicator.

Sterilization indicator, according to the conventional art, may be formed of amino acid and pH indicator. When the amino group of amino acid reacts with aldehyde and loses alkalinity, an acidity of amino acid, which becomes relatively strong by the carboxyl group, may react according to the pH indicator.

Further, chemical solution may be used in a semiconductor manufacturing process, and the chemical solution used in the semiconductor manufacturing process may leak in a semiconductor manufacturing apparatus. Chemical solution leaking to the semiconductor manufacturing apparatus may be wiped by using adsorption fabric and then the used-adsorption fabric may be classified and collected for disposal, according to the properties of a chemical solution adsorbed thereto. Such separation/collection disposition may prevent or reduce a fire occurrence causable within a separation/collection envelope due to a reaction between chemical solutions having different properties, e.g., acid and organic matter, acid and alkali, or alkali and organic matter.

Thus, the separation/collection envelopes may be distinguished from according to their colors. Adsorption fabric, which has been used in wiping acid in the chemical solution, may be separately collected into a red envelope, adsorption fabric used for alkali into a blue envelope, and adsorption fabric used for organic matter into a yellow envelope.

However, identifying the type of chemical among acid, alkali and organic matter that the adsorption fabric adsorbed during wiping of the chemical solution may be difficult. One may classify and/or collect the used adsorption fabric mistakenly into the separation/collection envelope, which also may cause a fire occurrence.

### SUMMARY

Accordingly, example embodiments provide a color-changing adsorption fabric, which changes color in order to identify which chemical among acid, alkali and organic matter has been wiped by the adsorption fabric, the color change being represented by a chemical reaction to a chemical solution. The color of the adsorption fabric may change in correspondence with a chemical when the chemical solution is wiped by the adsorption fabric, thereby preventing or reducing a fire occurrence causable by a mistaken-separation/collection. The adsorption fabric may be identified for a type of chemical with the naked eye after the adsorption fabric is used in wiping a chemical solution.

According to example embodiments, an adsorption fabric adsorbing chemical solution may include a material, wherein the color of the material changes when contacting an acid, alkali and organic matter so as to identify the type of chemical solution after the adsorption fabric is used in wiping the chemical solution.

The material may be applied to the adsorption fabric and the material may cover the adsorption fabric. The material may be a type of pH-indicator material, e.g., pH paper. The adsorption fabric may change to red when used in wiping an acid in the chemical solution, to blue when used in wiping an alkali in the chemical solution, or to yellow when used in wiping an organic matter in the chemical solution.

The material may be a pH measuring film formed of paper or fabric. The pH measuring film may adhere to front and rear faces of the adsorption fabric. The pH measuring film may change to red when used in wiping an acid in the chemical solution, to blue when used in wiping an alkali in the chemical solution, or to yellow when used in wiping an organic matter in the chemical solution.

According to example embodiments, a method of fabricating an adsorption fabric adsorbing chemical solution may include applying a material, wherein the color of the material changes when contacting an acid, alkali and organic matter so as to identify the type of chemical solution after the adsorption fabric is used in wiping the chemical solution, to the adsorption fabric.

Applying the material may include covering the adsorption fabric with the material and may include applying a type of pH-indicator material, e.g., a type of pH paper. The adsorption fabric may change to red when used in wiping an acid in the chemical solution, to blue when used in wiping an alkali in the chemical solution, or to yellow when used in wiping an organic matter in the chemical solution.

Applying the material may include applying a pH measuring film formed of paper or fabric. Applying the pH measuring film may also include adhering the pH measuring film to front and rear faces of the adsorption fabric.

As described above, according to example embodiments, a color of adsorption fabric may change by a chemical reaction between the material and the chemical solution used in wiping the chemical solution that leaks during a semiconductor manufacturing process, the material changing when contacting an acid, alkali or organic matter, thereby allowing identification with the naked eye whether the adsorption fabric has been used in wiping any chemical solution among the chemical solutions, and thus separately collecting the used-adsorption fabric so as to prevent or reduce a fire occurrence during disposal.

### DETAILED DESCRIPTION OF EXAMPLE EMBODIMENTS

Example embodiments will be described more fully hereinafter. Example embodiments may, however, be embodied in many different forms and should not be construed as limited to the embodiments set forth herein. Rather, example embodiments are provided so that this disclosure will be thorough and complete, and will fully convey the scope of example embodiments to those skilled in the art.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Like numbers indicate like elements throughout. As used herein the term “and/or” includes any and all combinations of one or more of the associated listed items.

It will be understood that, although the terms “first”, “second”, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of example embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of example embodiments.

Unless otherwise defined, all terms (including technical and scientific terms) used herein have the same meaning as commonly understood by one of ordinary skill in the art to which example embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

According to example embodiments, a material, whose color changes when contacting acid, alkali or organic matter, may be applied to an adsorption fabric so as to identify a type of chemical solution stained on the adsorption fabric, thereby obtaining the adsorption fabric of example embodiments. The material, whose color changes when contacting acid, alkali or organic matter, may be pH-indicator material. The adsorption fabric may soak in the material having the color-changing properties. Further, the adsorption fabric may be covered with a material having color-changing properties in correspondence with a chemical solution, surrounding or enclosing the adsorption fabric.

A chemical solution used in the semiconductor manufacturing process may be acid, alkali, or organic matter, and acid, alkali or organic matter leaking during the semiconductor process may be wiped by using an adsorption fabric. After wiping the chemical solution, adsorption fabric stained with acid may become red with an acidity of, e.g., under about 5.0 pH, and adsorption fabric stained with alkali may change to blue with an acidity of, e.g., about 0.8 pH or more. Adsorption fabric stained with organic matter may become yellow with an acidity of, e.g., about 6.0 pH˜about 7.0 pH.

pH is a measure of the acidity of a solution in biological and chemical systems and is calculated by the formula ‘pH=−log₁₀[H+]’. In other words, the pH scale is an inverse logarithmic representation of hydrogen ion concentration. The hydrogen ion concentration of solution may be a relatively small value, and thus, inconvenient for processing.

An acid level of solution may be represented as hydrogen ion concentration or pH. The acid level may be termed “acidity”, and may be obtained according to a scale that depends upon a discharged level of proton from the acid (AH) when dissolving the acid (AH) in a solvent (S). For example, in an equilibrium state, e.g., AH+S [symbol] A⁻+Hs⁺, an equilibrium constant, that is, acid dissociation constant K_{A} may be obtained through the following mathematical formula 1. In the mathematical formula 1, the square brackets are usually taken to signify concentration.

$${K}_{A} = \frac{[ {A}^{-} ] [ {Hs}^{+} ]}{[ AH ] [ S ]} \qquad [ Mathematical Formula 1 ]$$

When there is a relatively large amount of solvent, [S] may be constant, thus K_{A} may be obtained through the following mathematical formula 2.

$${K}_{A} = \frac{[ {A}^{-} ] [ {Hs}^{+} ]}{[ AH ]} \qquad [ Mathematical Formula 2 ]$$

In this case, pK_{A} known as the acidity constant or acid-ionization constant is equal to minus the decimal logarithm of K_{A} (that is, pK_{A}=−log₁₀ K_{A}). pH is deviated from the Henderson-Hasselbalch equation using pK_{A}.

Accordingly, according to example embodiments, a color of adsorption fabric used in wiping acid, alkali or organic matter may change to red, blue or yellow in sequence, thus distinguishing which type of chemical solution was wiped through the color change of adsorption fabric. Therefore, the mistakenly separated or collected adsorption fabric of a separation or collection envelope may be removed and then properly disposed with the used-adsorption fabric, thus preventing or reducing a fire occurrence.

According to example embodiments, a pH measuring film formed of fabric or paper may adhere to front and rear faces of the adsorption fabric. A pH measuring film may adhere to the adsorption fabric to measure acidity through a change of color. Thus, a color of the adsorption fabric may change according to the properties of chemical solution when the adsorption fabric is used in wiping the chemical solution.

When used in wiping acid, the pH measuring film of the adsorption fabric may change to red, when used in wiping alkali of chemical solution, the pH measuring film may change to blue, and when used in wiping organic matter, the pH measuring film may change to yellow.

In example embodiments described above, material, whose color changes when contacting acid, alkali or organic matter, may be applied to an adsorption fabric or a pH measuring film may adhere to the adsorption fabric. However, example embodiments also provide that the adsorption fabric may be surrounded or enclosed with pH paper or the pH paper may adhere to the adsorption fabric.

It will be apparent to those skilled in the art that modifications and variations may be made in example embodiments without deviating from the spirit or scope of example embodiments. Thus, example embodiments cover any such modifications and variations of example embodiments provided they come within the scope of the appended claims and their equivalents. For example, applying a material, whose color changes when contacting acid, alkali or organic matter, to an adsorption fabric. Accordingly, these and other changes and modifications are within the true spirit and scope of example embodiments as defined by the appended claims.

In the specification, example embodiments have been disclosed, and although specific terms are employed, they are used in a generic and descriptive sense only and not for purposes of limitation, the scope being set forth in the following claims.

What is claimed is:

1. An adsorption fabric adsorbing chemical solution comprising:
a material, wherein the color of the material changes when contacting an acid, alkali and organic matter so as to identify the type of chemical solution after the adsorption fabric is used in wiping the chemical solution.

2. The fabric of claim 1, wherein the material is applied to the adsorption fabric.

3. The fabric of claim 2, wherein the material covers the adsorption fabric.

4. The fabric of claim 1, wherein the material is a type of pH-indicator material.

5. The fabric of claim 1, wherein the material is a type of pH paper.

6. The fabric of claim 1, wherein the adsorption fabric changes to red when used in wiping an acid in the chemical solution.

7. The fabric of claim 1, wherein the adsorption fabric changes to blue when used in wiping an alkali in the chemical solution.

8. The fabric of claim 1, wherein the adsorption fabric changes to yellow when used in wiping an organic matter in the chemical solution.

9. The fabric of claim 1, wherein the material is a pH measuring film formed of paper or fabric.

10. The fabric of claim 9, wherein the pH measuring film adheres to front and rear faces of the adsorption fabric.

11. The fabric of claim 9, wherein the pH measuring film changes to red when used in wiping an acid in the chemical solution.

12. The fabric of claim 9, wherein the pH measuring film changes to blue when used in wiping an alkali in the chemical solution.

13. The fabric of claim 9, wherein the pH measuring film changes to yellow when used in wiping an organic matter in the chemical solution.

14. A method of fabricating an adsorption fabric adsorbing chemical solution comprising:
applying a material, wherein the color of the material changes when contacting an acid, alkali and organic matter so as to identify the type of chemical solution after the adsorption fabric is used in wiping the chemical solution, to the adsorption fabric.

15. The method of claim 14, wherein applying the material includes covering the adsorption fabric with the material.

16. The method of claim 14, wherein applying the material includes applying a type of pH-indicator material.

17. The method of claim 14, wherein applying the material includes applying a type of pH paper.

18. The method of claim 14, wherein the adsorption fabric changes to red when used in wiping an acid in the chemical solution.

19. The method of claim 14, wherein the adsorption fabric changes to blue when used in wiping an alkali in the chemical solution.

20. The method of claim 14, wherein the adsorption fabric changes to yellow when used in wiping an organic matter in the chemical solution.

21. The method of claim 14, wherein applying the material includes applying a pH measuring film formed of paper or fabric.

22. The method of claim 21, wherein applying the pH measuring film includes adhering the pH measuring film to front and rear faces of the adsorption fabric.
